(19) United States
(12) Patent Application Publication
(10) Pub. No.: US 2026/0093648 A1
(43) Pub. Date: Apr. 2, 2026

(54) PSEUDO-ACTIVE LINK STATE FOR MULTI-DIE LINK FAILURE

(71) Applicants: Advanced Micro Devices, Inc., Santa Clara, CA (US); ATI Technologies ULC, Markham (CA)

(72) Inventors: David Akselrod, Markham (CA); Alexander J. Branover, Boxborough, MA (US); Robert Landon Pelt, Austin, TX (US); Todd David Basso, Boxborough, MA (US); Trevor Pogue, Markham (CA)

(73) Assignees: Advanced Micro Devices, Inc., Santa Clara, CA (US); ATI Technologies ULC, Markham (CA)

(21) Appl. No.: 18/899,603

(22) Filed: Sep. 27, 2024

(51) Int. Cl. G06F 13/36

(52) U.S. Cl. CPC G06F 13/36; G06F 2213/40

(57) ABSTRACT

The disclosed device includes a communication link between chiplets and a control circuit near a physical layer of the link for one of the chiplets. When the link becomes inactive, the control circuit can mimic an active status of the link including intercepting packets and injecting mimicked responses, to allow graceful failover or other debugging. Various other methods, systems, and computer-readable media are also disclosed.

### BACKGROUND

As computing demands increase, processor architectures have advanced to meet the computing demands. For example, a processor architecture can include multiple processors, either as multiple cores (or dies) in a package, or multiple processors on different sockets or on different chiplets (aka silicone dies). The multiple processors can be connected via communication links for sending/receiving data such that the multiple processors can coordinate operations. The multiple processors also coordinate debugging features/commands. However, these debugging features often require fully functioning links.

### BRIEF DESCRIPTION OF THE DRAWINGS

The accompanying drawings illustrate a number of exemplary implementations and are a part of the specification. Together with the following description, these drawings demonstrate and explain various principles of the present disclosure.

FIG. 1 is a block diagram of an example system for debug support for multi-die link failure.

FIG. 2 is a diagram of an example multi-die link system.

FIG. 3 is a diagram of an example link.

FIG. 4A-B are diagrams of example flow controls.

FIG. 5 is a diagram of metadata insertion.

FIG. 6 is a flow diagram of an exemplary method for debug support for multi-die link failure.

Throughout the drawings, identical reference characters and descriptions indicate similar, but not necessarily identical, elements. While the exemplary implementations described herein are susceptible to various modifications and alternative forms, specific implementations have been shown by way of example in the drawings and will be described in detail herein. However, the exemplary implementations described herein are not intended to be limited to the particular forms disclosed. Rather, the present disclosure covers all modifications, equivalents, and alternatives falling within the scope of the appended claims.

### DETAILED DESCRIPTION

The present disclosure is generally directed to a pseudo-active state for multi-die link failure in which an inactive link is simulated to be active to maintain functionalities requiring the active link. As will be explained in greater detail below, some implementations of the present disclosure include a chiplet or other integrated circuit (IC) communicatively coupled to another chiplet/IC via a link, and a control circuit configured to mimic (e.g., simulate) an active status of the link, such as in response to the link becoming inactive. In some other implementations, a standalone integrated circuit (IC) is communicatively coupled to another IC via a link, and a control circuit can be configured to simulate an active status of the link, such as in response to the link becoming inactive. In yet other implementations, the control circuit can be configured to simulate an active link status for any inactive link, such as links between any pairing between chiplets, ICs (e.g., between two chips on a computer board and/or remotely located chips on separate boards), subcomponents of ICs, etc. By mimicking the active status to establish a pseudo-active link status, the systems and methods provided herein advantageously allow the corresponding chiplet or IC to maintain functionality that requires an active link, such as certain debugging and diagnostic operations. The systems and methods described herein allow the chiplet or an IC to perform debugging operations even after the link fails, which can further allow other chiplets (or ICs) to also perform debugging operations.

Features from any of the implementations described herein can be used in combination with one another in accordance with the general principles described herein. These and other implementations, features, and advantages will be more fully understood upon reading the following detailed description in conjunction with the accompanying drawings and claims.

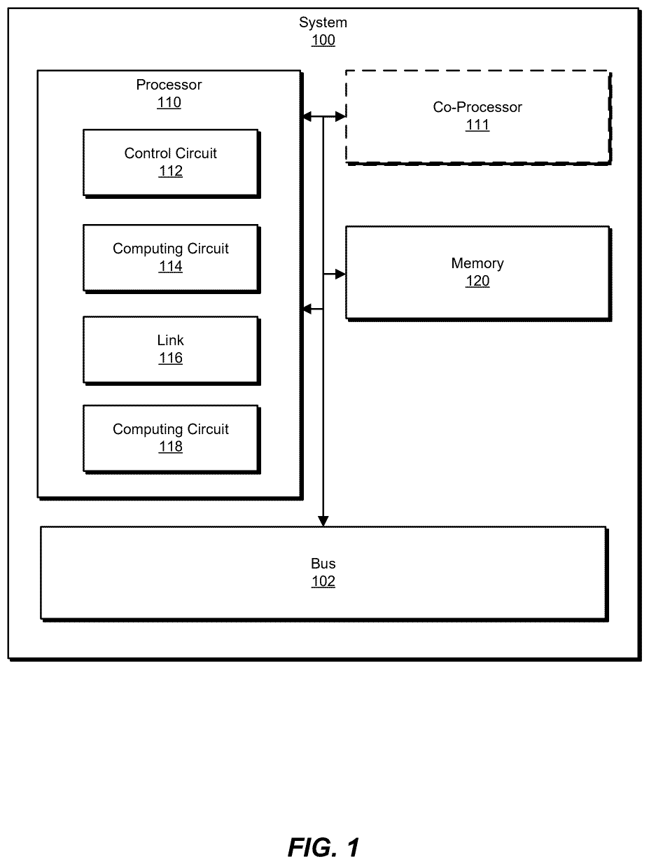

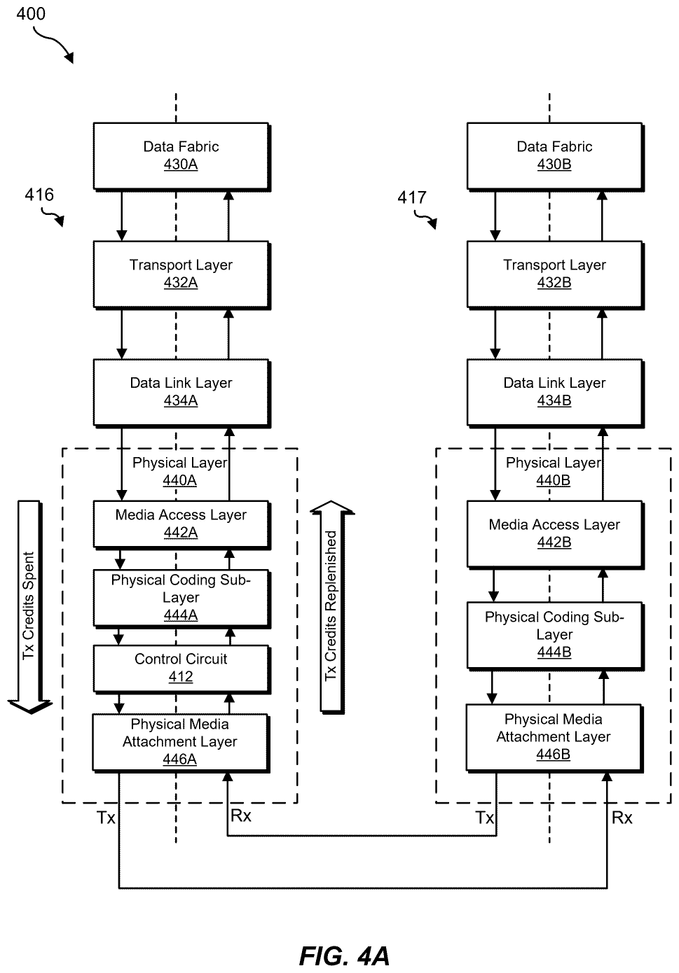

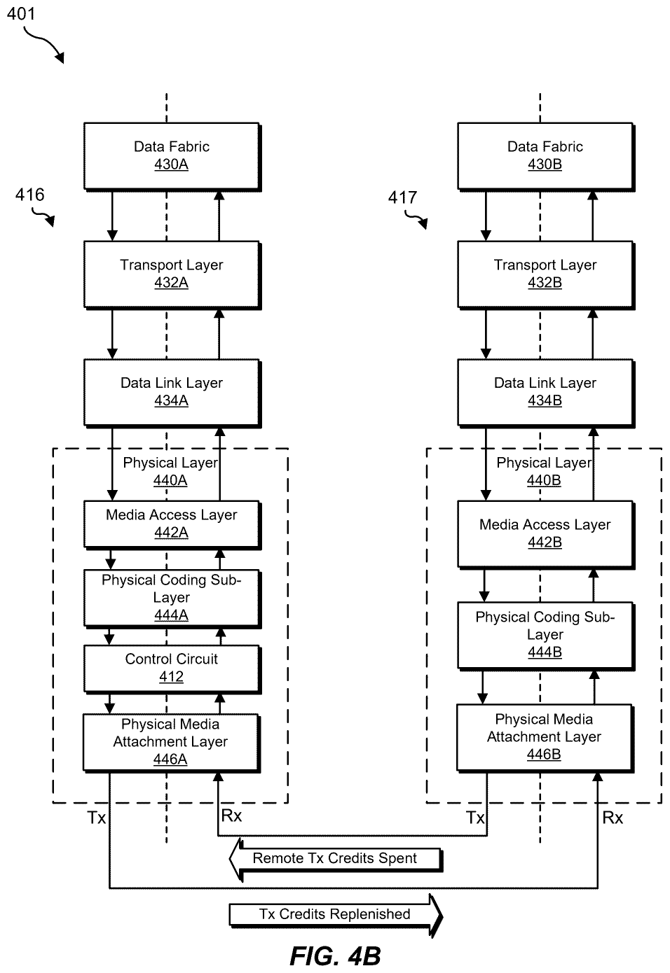

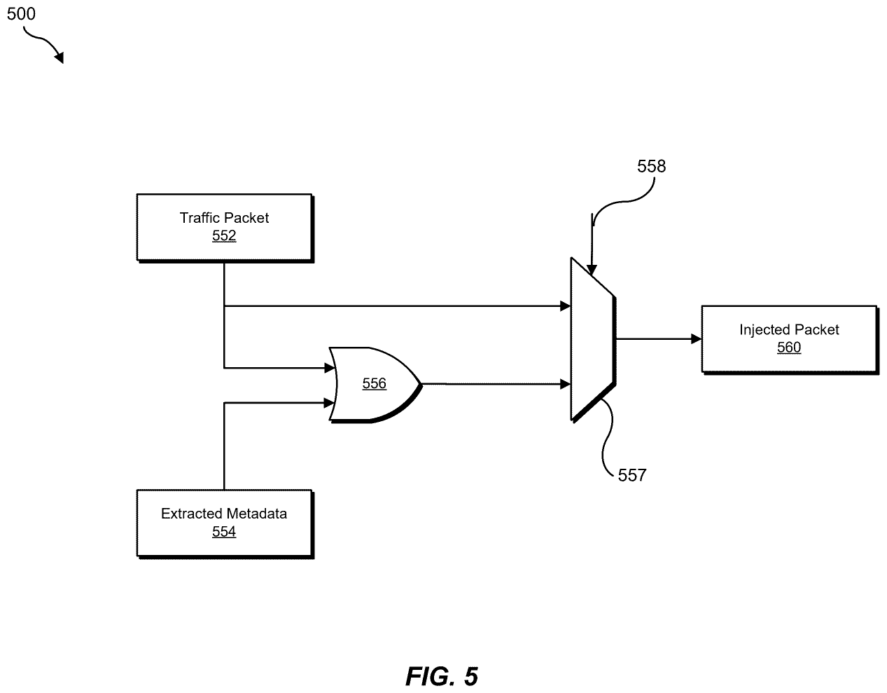

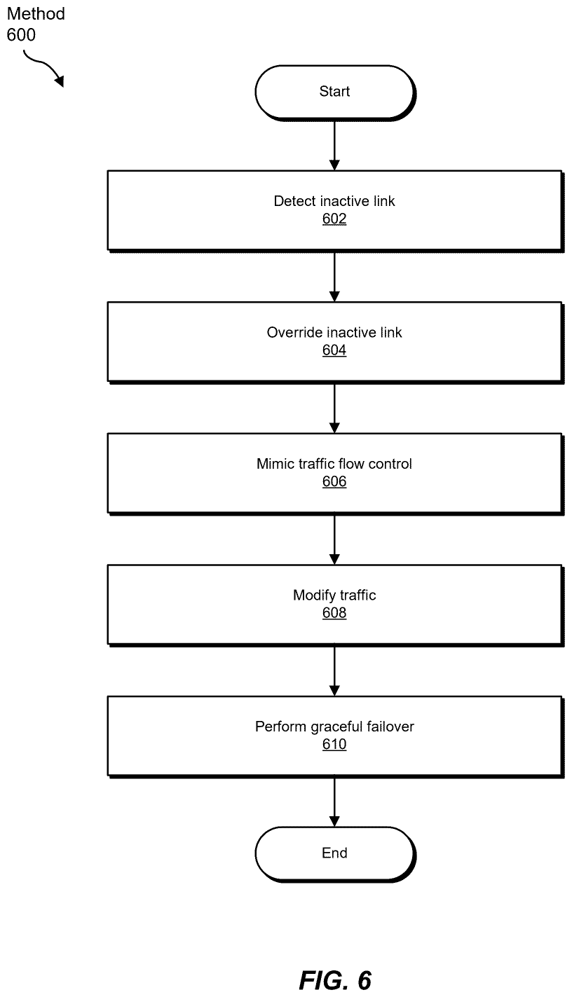

The following will provide, with reference to FIGS. 1-6, detailed descriptions of supporting a pseudo-active link status for multi-die and/or multi-IC links. Detailed descriptions of example systems and devices will be provided in connection with FIGS. 1-3. Detailed descriptions of flow control for packets will be provided in connection with FIGS. 4A-4B. Detailed descriptions of metadata management will be provided in connection with FIG. 5. Detailed descriptions of corresponding methods will also be provided in connection with FIG. 6.

FIG. 1 is a block diagram of an example system 100 for a pseudo-active link state for multi-die link failure. System 100 corresponds to a computing device, such as a desktop computer, a laptop computer, a server, a tablet device, a mobile device, a smartphone, a wearable device, an augmented reality device, a virtual reality device, a network device, and/or an electronic device. As illustrated in FIG. 1, system 100 includes one or more memory devices, such as memory 120. Memory 120 generally represents any type or form of volatile or non-volatile storage device or medium capable of storing data and/or computer-readable instructions. Examples of memory 120 include, without limitation, Random Access Memory (RAM), Read Only Memory (ROM), flash memory, Hard Disk Drives (HDDs), Solid-State Drives (SSDs), optical disk drives, caches, variations, or combinations of one or more of the same, and/or any other suitable storage memory.

As illustrated in FIG. 1, example system 100 includes one or more physical processors, such as processor 110, which can correspond to one or more processors (e.g., a host processor along with a co-processor, which in some examples can be separate processors). Processor 110 generally represents any type or form of hardware-implemented processing unit capable of interpreting and/or executing computer-readable instructions. In some examples, processor 110 accesses and/or modifies data and/or instructions stored in memory 120. Examples of processor 110 include, without limitation, one or more instances of chiplets (e.g., smaller and in some examples more specialized processing units that can coordinate as a single chip), microprocessors, microcontrollers, Central Processing Units (CPUs), Field-Programmable Gate Arrays (FPGAs) that implement softcore processors, Application-Specific Integrated Circuits (ASICs), systems on chip (SoCs), digital signal processors (DSPs), Neural Network Engines (NNEs), accelerators, accelerated processing units (APUs), neural processing units (NPUs), tensor processing units (TPUs), other highly parallel processor units (PPUs), portions of one or more of the same, variations or combinations of one or more of the same (e.g., a host processor and a co-processor), and/or any other suitable physical processor(s). Further, in some examples, processor 110 can be a general-purpose processor that can be capable, without significant limitation, of various computing tasks, as opposed to a special purpose processor that can be limited in computing tasks (e.g., specially designed for particular computing tasks such as moving data, performing certain mathematical operations, etc.), although in other examples processor 110 can correspond to and/or incorporate one or more special purpose processors.

As also illustrated in FIG. 1, example system 100 can in some implementations optionally include one or more physical co-processors, such as co-processor 111, which in other implementations can be integrated with or otherwise represented by processor 110. Co-processor 111 generally represents any type or form of hardware-implemented processing unit capable of interpreting and/or executing computer-readable instructions, which in some examples works in conjunction and/or based on instructions from a host/main processor such as a CPU (e.g., processor 110). In some examples, co-processor 111 accesses and/or modifies data and/or instructions stored in memory 120. Examples of co-processor 111 include, without limitation, chiplets (e.g., smaller and in some examples more specialized processing units that can coordinate as a single chip), microprocessors, microcontrollers, graphics processing units (GPUs), Field-Programmable Gate Arrays (FPGAs) that implement softcore processors, Application-Specific Integrated Circuits (ASICs), systems on chip (SoCs), digital signal processors (DSPs), Neural Network Engines (NNEs), accelerators, accelerated processing units (APUs), neural processing units (NPUs), tensor processing units (TPUs), other highly parallel processor units (PPUs), portions of one or more of the same, variations or combinations of one or more of the same, and/or any other suitable physical processor.

FIG. 1 also includes a bus 102 that can correspond to any bus, circuitry, connections, and/or any other communicative pathways for sending communicative signals, based on one or more communication protocols, between components/devices (e.g., processor 110, memory 120, and/or co-processor 111, etc.). In some implementations, bus 102 can further connect, via wireless and/or wired connections, to other devices, such as peripheral devices external to or partially integrated with system 100. Although not illustrated in FIG. 1, in some implementations, system 100 can be coupled to a display device (e.g., via bus 102).

As further illustrated in FIG. 1, processor 110 includes a control circuit 112, a computing circuit 114, a link 116, and a computing circuit 118. Control circuit 112 corresponds to one or more circuits and/or circuitry and/or logic (e.g., such as a microprocessor and/or other controller) for providing a pseudo-active link state (e.g., simulating an active state during an actual inactive state for a link) such as during link failure (e.g., a failure of link 116) by mimicking an active state of the failed or otherwise inactive link, for example by inducing, controlling, and/or propagating an active status of the link. Computing circuit 114 and computing circuit 118 each correspond to different iterations of a processing element, such as a die (e.g., a semiconductor structure including processing circuits as integrated circuits), core (e.g., a processor as part of an overall central processing unit (CPU)), chiplet, etc. of processor 110. Link 116 corresponds to a communication link (e.g., having a transmit channel and paired a receive channel) for computing circuit 114 to communicate with computing circuit 118 (e.g., by sending/receiving datagrams data signals, and/or other data messages such as packets) as computing circuit 118 can be external to computing circuit 114 (e.g., located on a different die and/or socket). In some examples, computing circuit 114 and computing circuit 118 can represent different dies/cores/chiplets of a processor (e.g., processor 110) on a same socket. In other examples, although not explicitly shown in FIG. 1, computing circuit 114 and computing circuit 118 can represent different dies/cores/chiplets of processors on different sockets (e.g., processor 110 including computing circuit 114 on one socket, and co-processor 111 including computing circuit 118 on a different socket). Moreover, each of the circuits described herein (e.g., computing circuit 114 and/or computing circuit 118) can represent any type of computing circuitry (e.g., processors, co-processors, accelerators, one or more ICs, etc.), subcomponents thereof, and/or any type of circuit. Accordingly, link 116 can correspond to or otherwise represent one or more circuits, components, etc. for establishing a complete data communication channel between computing circuit 114 and computing circuit 118. As will be explained further below, link 116 can include various layers for transmitting and receiving data signals. Moreover, although FIG. 1 illustrates a single link 116, in some implementations, each computing circuit (e.g., computing circuit 114 and computing circuit 118) can have a corresponding iteration of link 116.

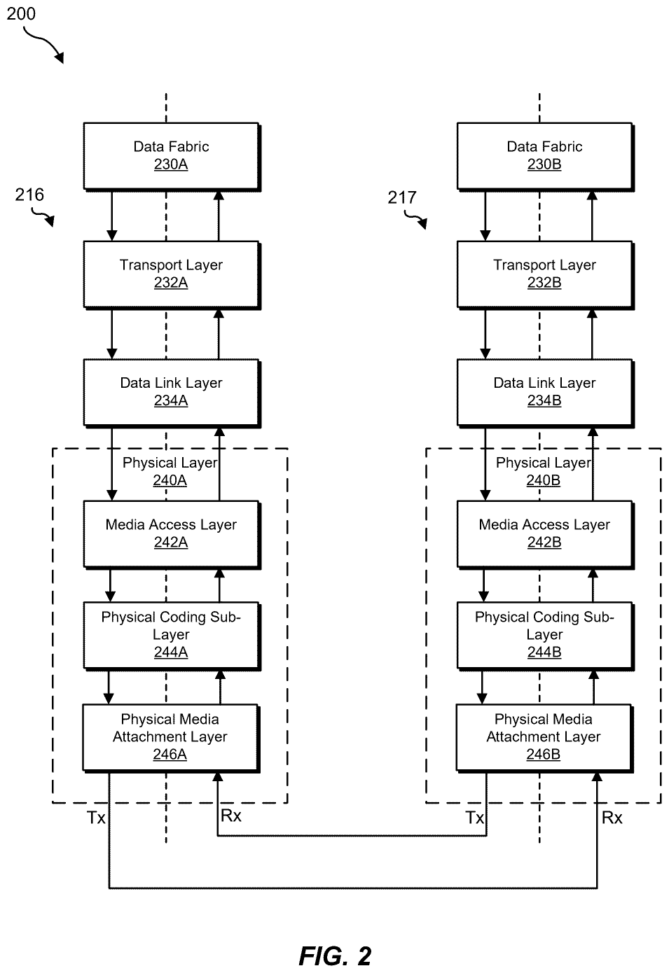

FIG. 2 illustrates a system 200 corresponding to system 100, and more specifically illustrates a communication path between two computing circuits (e.g., computing circuit 114 and computing circuit 118) that includes links (e.g., iterations of link 116). In FIG. 2, a link 216 (e.g., on the left side of FIG. 2) can correspond to a link for a first computing circuit (e.g., computing circuit 114) and a link 217 (e.g., on the right side of FIG. 2) can correspond to a link for a second computing circuit (e.g., computing circuit 118) that is external to the first computing circuit.

A data fabric 230A and a data fabric 230B can each represent an architecture (e.g., signal paths and structures) for sending data signals to the respective computing circuits. A transport layer (TL) 232A and a transport layer 232B can each represent a high and/or highest level of a communication link for sending and receiving data. A data link layer (DLL) 234A and a data link layer 234B can each represent a level of a communication link for sending and receiving data as frames (of bits) in accordance with a data protocol.

Link 216 includes a physical layer 240A and link 217 includes a physical layer 240B, each physical layer representing a low and/or lowest level of a communication link for physical hardware components (e.g., wiring, connectors, etc.) and can include additional layers. A media access layer 242A (e.g., a media access control (MAC)) and a media access layer 242B can each represent a layer for controlling hardware for sending and receiving bits, for example by encapsulating bits as appropriate for the corresponding physical medium. A physical coding sub-layer (PCS) 244A and a physical coding sub-layer 244B can each represent a sublayer for determining a functional link and can further encode/decode data signals. A physical media attachment layer (PHY) 246A and a physical media attachment layer 246B can each represent a transceiver for the physical medium. FIG. 2 illustrates an example architecture of a link, although in other implementations other link architectures can be used. Further, FIG. 2 illustrates example connection of layers of the architecture, which can be physically arranged in any appropriate layout.

As illustrated in FIG. 2 for explanatory purposes, a transmit (Tx) channel (e.g., a left side of each of link 216 and link 217 and further corresponding to an initiator channel) can propagate data signals from the initiator such as the sender's data fabric (e.g., data fabric 230A and data fabric 230B, respectively) down through the various downstream layers (e.g., TL, DLL, MAC, PCS, PHY, including conversions as needed) which are then transmitted to a receive (Rx) channel (e.g., a right side of each of link 216 and link 217 and further corresponding to a response channel) of the other link. The received data signals can be propagated up through the various upstream layers (e.g., PHY, PCS, MAC, DLL, TL, including conversions as needed) to be sent to the receiver, such as the receiver's data fabric (e.g., data fabric 230B and data fabric 230A, respectively).

An active state for a link indicates that the link is ready and able to send/receive data, which can further correspond to being sufficiently powered, detecting signal strength within acceptable thresholds, etc. With respect to link 216, physical layer 240A (and/or layers therein) can detect the active state, and propagate this active state up the upstream layers, such as through a handshake operation. In some instances, an error, failure, and/or other unexpected condition in the communication path can cause physical layer 240A to become inactive. For example, a hardware failure in the physical medium and/or wires connecting to link 217, a failure in link 217 and/or any layer therein, a failure of any component coupled to link 217 (e.g., the link partner is unavailable), etc. can terminate the active state for link 216. In such instances, physical layer 240A and/or a layer therein can propagate the inactive state up the layers. In some examples, a lack of propagating the active state can correspond to propagating the inactive state.

The computing circuit coupled to link 216 often requires link 216 to be in the active state to perform various operations. In other words, the computing circuit can be limited to a subset of operations with link 216 is in the inactive state. In certain scenarios, this restriction can be undesirable. For example, certain debugging and diagnostic functionalities can be limited or unavailable when link 216 is in the inactive state. However, when an error in the overall system contributes to the inactive state, it can be desirable to be able to perform the debugging and diagnostic functions as needed.

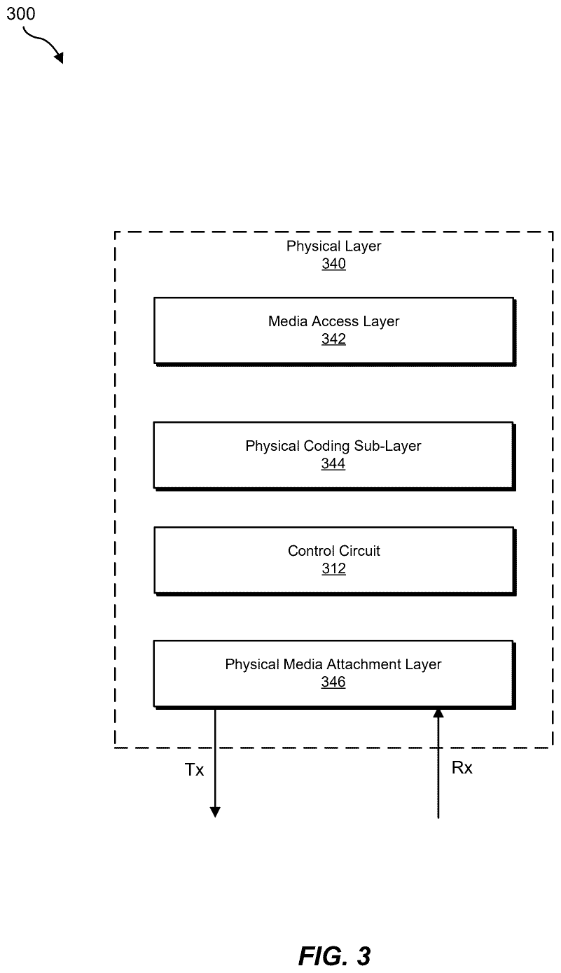

FIG. 3 illustrates a system 300 corresponding to system 100, and more specifically to a link such as link 116 and/or link 216. FIG. 3 illustrates a physical layer 340 (corresponding to physical layer 240A) that includes a media access layer 342 (corresponding to media access layer 242A), a physical coding sub-layer 344 (corresponding to physical coding sub-layer 244A), and a physical media attachment layer 346 (corresponding to physical media attachment layer 246A). Physical layer 340 further includes a control circuit 312 (corresponding to control circuit 112).

As illustrated in FIG. 3, control circuit 312 can be coupled between physical media attachment layer 346 and physical coding sub-layer 344, allowing control circuit 312 to reside in both Tx and Rx channels, and more specifically near the physical medium. Control circuit 312 can accordingly influence the communication channels. In some implementations, control circuit 312 can have various modes of operation corresponding to levels of influencing/affecting the communication channels.

In a first mode (e.g., corresponding to a link override), control circuit 312 can detect that the link is inactive and accordingly mimic the active state, for example by imitating the handshake operation to propagate the active status upstream and enabling a pseudo-active state (e.g. by means of overriding signals indicating to nearby or remote components such as physical media attachment layer 246A, physical coding sub-layer 244A, media access layer 242A, data link layer 234A, transport layer 232A, data fabric 230A, etc.). For example, control circuit 312 can detect a link failure (e.g., by inspecting signals from physical media attachment layer 346 and/or other coupled layers) and in response, perform the handshake operation such that upstream layers and/or components (e.g., computing circuits) can continue operating in the pseudo-active state as if the link is actually active, even if no real data is actually transmitted and/or received through the link. In some examples, control circuit 312 can provide a permanent or otherwise persistent link override (e.g., maintaining the pseudo-active state) until an actual active state returns. In other examples, control circuit 312 can provide a transient or otherwise temporary link override, for example maintaining the pseudo-active state for a limited duration (e.g., number of cycles, period of time, other conditions are met, etc.). As will be described further below, in some implementations, control circuit 312 can further mimic packets being sent on the Tx channel and/or received on the Rx channel. In some implementations, despite physical layer 340 as a whole indicating inactive link status, one or more remote components (e.g., physical media attachment layer 246A, physical coding sub-layer 244A, media access layer 242A, data link layer 234A, transport layer 232A, and/or data fabric 230A), can override such status.

In a second mode (e.g., a transparent mode), control circuit 312 can intercept certain packets from the Tx channel and inject certain packets into the Rx channel while the link is active. For example, control circuit 312 can monitor the Tx channel for a pattern of interest. For example, if control circuit 312 intercepts an outgoing packet matching the pattern, control circuit 312 can drop the outgoing packet by preventing the packet from being sent or otherwise sending a default/null packet, and mimicking the transmission of the packet, for example by injecting an expected response packet on the Rx channel. Examples of patterns can include patterns based on type of packet (e.g., error indications/notifications, types of errors, etc.), sources/destinations, etc. For instance, an outgoing packet can correspond to an error indication (e.g., a critical failure or other error) and the mimicked response can correspond to a debug command for addressing the error. In other examples, control circuit 312 can monitor the reverse (e.g., monitor incoming packets on the Rx channel for matching a pattern of interest and intercepting outgoing packets corresponding to the matched incoming packets).

In some implementations, control circuit 312 can switch between modes. For instance, control circuit 312 can operate in the transparent mode while the link is active, and switch to the link override mode in response to the link becoming inactive. When the link becomes active again, control circuit 312 can fall back to the transparent mode. In other implementations, control circuit 312 can operate in both modes, and in further implementations, can be selectively disabled (e.g., operating in neither mode).

Although FIG. 3 illustrates control circuit 312 as being coupled between physical media attachment layer 346 and physical coding sub-layer 344, in other implementations control circuit 312 can be coupled between any other layers (e.g., between physical coding sub-layer 344 and media access layer 342), can be coupled between layers outside of physical layer 340 (e.g., in reference to FIG. 2, between media access layer 242A and data link layer 234A, between data link layer 234A and transport layer 232A, and/or between transport layer 232A and data fabric 230A), and further can be coupled at more than one level of the link (e.g., coupled between multiple pairs of levels). Moreover, control circuit 312 can be integrated with one or more of the layers described herein.

In some examples, communication protocols contain underlying flow control techniques for regulating data flow. Accordingly, in some implementations, mimicking/simulating the active state can include mimicking/simulating a flow control for the Tx and Rx channels. FIGS. 4A-4B respectively illustrate a system 400 and a system 401, each corresponding to system 200, and more specifically illustrating a flow control for a communication path.

FIGS. 4A-4B illustrates a data fabric 430A (corresponding to data fabric 230A) coupled to a link 416 (corresponding to link 216) and a data fabric 430B (corresponding to data fabric 230B) coupled to a link 417 (corresponding to link 217). Link 416 includes a transport layer 432A (corresponding to transport layer 232A), a data link layer 434A (corresponding to data link layer 234A) and a physical layer 440A (corresponding to physical layer 240A). Physical layer 440A includes a media access layer 442A (corresponding to media access layer 242A), a physical coding sub-layer 444A (corresponding to physical coding sub-layer 244A), and a physical media attachment layer 446A (corresponding to physical media attachment layer 246A). Link 417 includes a transport layer 432B (corresponding to transport layer 232B), a data link layer 434B (corresponding to data link layer 234B), and a physical layer 440B (corresponding to physical layer 240B). Physical layer 440B includes a media access layer 442B (corresponding to media access layer 242B), a physical coding sub-layer 444B (corresponding to physical coding sub-layer 244B), and a physical media attachment layer 446B (corresponding to physical media attachment layer 246B).

In some implementations, a flow control scheme (which can be controlled by one or more of the layers described herein) can include tokens or credits, and/or other marker elements which are part of flow control schemes, which can manage how many packets are transmitted with respect to how many packets are received. In such flow control schemes, the tokens or credits can indicate availability to transmit or receive (e.g., each token/credit indicating availability to transmit/receive a packet). In other words, transmitting (or receiving) a packet is allowed for a given packet if a token/credit is available for the packet. The flow control scheme can mitigate overwhelming a link partner (e.g., a receiver on link 417) with packets, for example if the receiver receives packets at a faster rate than the receiver can process packets. In FIG. 4A, as a transmit credit counter can update based on sent/received packets. As packets are sent, the transmit credits are sent (e.g., decrementing the transmit credit counter). As packets (e.g., responses) are received, the transmit credits are replenished (e.g., incrementing the transmit credit counter). In some implementations, the flow control scheme can use a 1-to-1 correspondence of packets to credits, although in other implementations, other correspondences can be used (e.g., each packet indicating a number of credits).

When all the transmit credits are spent (e.g., the transmit credit counter is at zero), further packets can be delayed from transmitting until the transmit credits are restored. However, when a control circuit 412 (corresponding to control circuit 112 and/or control circuit 312, and in other implementations can reside at other layers as described herein) mimics the active status, outgoing packets can be treated as sent (e.g., decrementing the transmit credit counter) which can lead to running out of transmit credits. To avoid this, control circuit 412 can further mimic aspects of the flow control during the pseudo-active link state. In one implementation, control circuit 412 can make transmit tokens always available (e.g., by ignoring the transmit credit counter for outgoing packets and/or by not decrementing the transmit credit counter for outgoing packets). In another implementation, control circuit 412 can allow the transmit credit counter to decrement for the outgoing packet and accordingly increment the transmit credit counter for the corresponding mimicked response. More specifically, control circuit 412 can decode incoming Tx traffic (e.g., outgoing packets) to distinguish a specific channel for each packet (e.g., a request channel, a response channel, a probe channel, a request data channel, a response data channel, etc.). Control circuit 412 can return or otherwise inject a credit for the corresponding channel, in order to mimic “replenishing” spent credits.

FIG. 4B illustrates when control circuit 412 injects traffic from the outside (e.g., mimicking incoming packets in the Rx channel) and intercepting a response (e.g., outgoing packets in the Tx channel). In some implementations, the link partner can provide a number of remote transmit credits used, such that an outgoing response can indicate a number of remote transmit credits to replenish. Control circuit 412 can mimic the spending and replenishing of the remote transmit credits similar to the transmit credits as described above.

FIG. 5 illustrates a system 500 (corresponding to system 100) and more specifically, aspects of a control circuit (e.g., control circuit 112). In some implementations, a metadata exchange ensures proper matching of outgoing and incoming packets in transfer protocols (e.g., transmissions and responses). The control circuit can further mimic the metadata exchange.

The control circuit can extract, as extracted metadata 554, metadata from an intercepted outgoing or incoming packet and stored. In some examples, metadata can correspond to any data additional to a payload of the packet, such as address data (e.g., source and/or destination addresses), counters (e.g., for tracking one or more features such as credits), identifiers (e.g., a tag ID for identifying and matching requests and responses), etc. For a traffic packet 552, corresponding to a mimicked packet (e.g., based on a pre-loaded response packet pattern corresponding to the intercepted packet) matching with the intercepted packet (e.g., an outgoing response to an intercepted incoming request, an incoming response for an intercepted outgoing request, etc.), the control circuit can combine extracted metadata 554 with traffic packet 552 using a combiner circuit 556. In some implementations, traffic packet 552 can include zero values for its metadata section such that combiner circuit 556 can correspond to an OR gate that performs OR operations on the bits of extracted metadata 554 with corresponding locations of metadata bits in traffic packet 552. In other implementations, combiner circuit 556 can correspond to another circuit for writing extracted metadata 554 into traffic packet 552 at the metadata location(s). In some implementations, combiner circuit 556 can extract a number of fields from the intercepted packets and re-introduce them in the corresponding mimicked responses, for example at different offsets dictated by the location of the metadata in the specific transfer protocol at hand.

Further, the control circuit can include a multiplexer 557 controlled by a select signal 558. When select signal 558 is set to enable metadata insertion, multiplexer 557 can output the combined traffic packet 552 and extracted metadata 554 (as output from combiner circuit 556) as an injected packet 560. When select signal 558 is set to disable metadata insertion, multiplexer 557 can output traffic packet 552 as injected packet 560. The control circuit can inject injected packet 560 into the appropriate channel (e.g., Tx or Rx channel).

In addition, in some implementations, the control circuit can implement one or more pre-programmed and/or programmable locations for extracting extracted metadata 554 and/or one or more pre-programmed and/or programmable locations of inserting/injecting extracted metadata 554 into traffic packet 552, for instance to allow the control circuit to extract certain metadata for certain types/patterns of packets. By extracting and injecting the metadata (e.g., tag ID), the mimicked packet (e.g., injected packet 560) can match the intercepted packet to fulfill the metadata exchange and conform to the corresponding transfer protocol.

FIG. 6 is a flow diagram of an example method 600 for supporting pseudo-active link state for multi-die link failure. The steps shown in FIG. 6 can be performed by any suitable system, including the system(s) illustrated in FIGS. 1-5. In one example, each of the steps shown in FIG. 6 represent an algorithm whose structure includes and/or is represented by multiple sub-steps, examples of which will be provided in greater detail below. In some implementations, steps shown in FIG. 6 are performed by hardware (e.g., digital circuits as described herein) and/or a combination of hardware and software/firmware.

As illustrated in FIG. 6, at step 602 one or more of the systems described herein detect an inactive link. For example, control circuit 112 can detect an inactive state of link 116. As described herein, control circuit 112 can actively detect the inactive state (e.g., by detecting an error with link 116) or passively detect the inactive state (e.g., by a lack of response and/or active status propagation from link 116 after a threshold amount of time and/or threshold number of cycles).

At step 604 one or more of the systems described herein override the inactive link. For example, control circuit 112 can override the inactive link state by establishing a pseudo-active state for link 116. As described herein, control circuit 112 can provide a permanent or transient link override. Further, control circuit 112 can shift between different modes as needed, such as between a link override mode and a transparent mode as described herein.

At step 606 one or more of the systems described herein mimic traffic flow control. For example, control circuit 112 can mimic traffic flow control by overriding transmit token counters (e.g., by ignoring values for the transmit token counter and/or artificially adjusting the transmit token counter to prevent zero tokens, etc.).

At step 608 one or more of the systems described herein modify traffic. For example, control circuit 112 intercept traffic (e.g., incoming and/or outgoing packets), extract metadata, and inject a corresponding response with matching metadata, as described herein.

At step 610 one or more of the systems described herein perform a graceful failover. For example, control circuit 112 can coordinate a graceful failover for processor 110. In some examples, a graceful failover can correspond to one or more operations for a graceful winding down of operation (e.g., including operations to prepare for ceasing and/or reducing operation) rather than an abrupt stop in operation. Examples of graceful failover can include injecting traffic to indicate that link 116 is down (e.g., allowing other components such as computing circuit 118 to react accordingly), performing a chiplet self-test mode, “winding down” and notifying other components, etc. Such graceful failover can allow debugging and/or diagnostic functions to continue. For instance, certain debugging operations require receiving and/or sending debugging messages through an active link, such that a failure of one link can disrupt and/or halt the debugging operations on system 100. By using the pseudo-active status as described herein, these debugging operations can continue. In some implementations some or all of the steps 602, 604, 606, 608, 610 can be performed in a different order from the one depicted in FIG. 6. Further, in some implementations one or more of the steps 602, 604, 606, 608, and/or 610 can be skipped.

In one example, system 100 can correspond to an automotive advanced driver-assistance system (ADAS) for a vehicle that can assist vehicle drivers with safe operation of the vehicle. In such an example, a critical chiplet communication failure can disadvantageously prevent any other debugging. By implementing the pseudo-active status as described herein, system 100 can continue certain debugging procedures, such as by allowing a chiplet to send sideband messages to have all chiplets enter a self-test diagnostic mode.

As detailed above, systems and methods for maintaining operation and debugging of multi-die or multi-socket systems under conditions of communication failures or limited functionality are provided. As described herein, an active link status override or forcing pseudo-active link state can include compensating flow-control for missing/inactive links, system Debugging under conditions of broken/failed links, mimicking metadata exchange under conditions of broken/failed links, and/or graceful failover mode for link failures.

The present disclosure provides a hardware and/or software-based eco-system allowing limited operation or graceful failover of critical systems or eco-systems involving communication channels in states when the communication links are not technically active or where only a subset of the overall system is available or operational. The present disclosure advantageously allows limited operation of the surrounding eco-system which otherwise depends on being in active state, alternative mode(s) of operation allowing faster recovery when the active link state is restored (thus maximizing overall up-time of the communication link), extended debugging and diagnostics functionality, mimicking tokens/credit exchange, mimicking metadata exchange, and/or graceful failover mode for link failures.

Certain examples, such as regular communication systems to safety-critical applications, automotive, or other instances where communication channels are used, both for chip-to-chip and chiplet-to-chiplet communication, can further benefit from mitigating the downtime of the

### Communication Link.

In some examples, the pseudo-active state or active state can be overridden if (1) link is not active or (2) no link partner is present. Allowing active link state override or a transition to the pseudo-active state provides for the imitation of an active link (e.g., a link-up) status to all other components that can be influenced by the link-up status. In some examples, mimicking/injecting flow control from unavailable or non-functional parts of the SoC or multi-socket system allows overall system debug, graceful failover, and/or limited operation. In some examples, the pseudo-active state includes mimicking/injecting metadata exchange, in the absence of link partner or in the case of non-functional or inactive link partner. Further, the pseudo-active state allows a graceful failover mode for link failures. Enabling Link-up override during communication failures allows for graceful wind down of components, such that the system can reach a predictable and stable shutdown state, communicating and informing of such event to internal and/or external components.

In some aspects, the techniques described herein relate to a device including: a first computing circuit configured to generate a data signal; a link configured to send the generated data signal to a second computing circuit and receive response signals from the second computing circuit; and a control circuit configured to simulate an active status of the link by controlling an active status visible to the first computing circuit.

In some aspects, the techniques described herein relate to a device, wherein the control circuit is configured to simulate the active status by inducing and propagating the active status of the link to the first computing circuit in response to the link being inactive.

In some aspects, the techniques described herein relate to a device, wherein the control circuit is configured to: intercept an outgoing data signal for a transmit channel of the link; and inject a mimicked response into a receive channel of the link that is paired to the transmit channel.

In some aspects, the techniques described herein relate to a device, wherein the control circuit is configured to: extract metadata from the intercepted outgoing data signal; and apply the metadata to the mimicked response.

In some aspects, the techniques described herein relate to a device, wherein the control circuit is configured to make a transmit credit available for the outgoing data signal, and wherein an availability of the transmit credit indicates the outgoing data signal is permitted to transmit.

In some aspects, the techniques described herein relate to a device, wherein the control circuit is configured to decrement a transmit credit counter quota status for the outgoing data signal.

In some aspects, the techniques described herein relate to a device, wherein the control circuit is configured to increment the transmit credit counter quota status by one of the mimicked responses.

In some aspects, the techniques described herein relate to a device, wherein the control circuit is configured to intercept, when the link is inactive, the outgoing data signal in response to the outgoing data signal matching a packet pattern.

In some aspects, the techniques described herein relate to a device, wherein the outgoing packet corresponds to an error indication and the mimicked response corresponds to a debug command.

In some aspects, the techniques described herein relate to a device, wherein the control circuit is configured to inject, in response to the link becoming inactive, a signal indicating a critical failure.

In some aspects, the techniques described herein relate to a system including: a memory; a first processor coupled to the memory; and a second processor coupled to the memory; wherein the first processor includes: one or more computing circuits configured to generate packets; a link configured to send the generated packets to the second processor and receive responses from the second processor; and a control circuit configured to simulate an active status of the link in response to an inactive status of the link by controlling the active status visible to the one or more computing circuits.

In some aspects, the techniques described herein relate to a system, wherein the control circuit is further configured to simulate the active status by propagating the active status of the link to the one or more computing circuits.

In some aspects, the techniques described herein relate to a system, wherein the control circuit is configured to: intercept an outgoing data signal for a transmit channel of the link; extract metadata from the intercepted outgoing data signal; and inject a mimicked response based on the metadata into a response channel of the link corresponding to the initiator channel.

In some aspects, the techniques described herein relate to a system, wherein the control circuit is configured to ignore a transmit credit counter for the outgoing data signal.

In some aspects, the techniques described herein relate to a system, wherein the control circuit is configured to: decrement a transmit credit counter quota status for the outgoing data signal; and increment the transmit credit counter quota status for the mimicked response.

In some aspects, the techniques described herein relate to a system, wherein the control circuit is configured to intercept, when the link is inactive, the outgoing data signal in response to the outgoing data signal matching a packet pattern.

In some aspects, the techniques described herein relate to a system, wherein the outgoing data signal corresponds to an error indication and the mimicked response corresponds to a debug command.

In some aspects, the techniques described herein relate to a system, wherein the control circuit is configured to inject, in response to the inactive status of the link, a signal that indicates a critical failure.

In some aspects, the techniques described herein relate to a method including: intercepting, by a control circuit in response to an inactive status of a link, an outgoing data signal from one or more computing circuits; extracting, by the control circuit, metadata from the intercepted outgoing data signal; and propagating, by the control circuit to the one or more computing circuits, a mimicked response based on the metadata.

In some aspects, the techniques described herein relate to a method, wherein at least one of the outgoing data signal or the mimicked response corresponds to an error indication.

As detailed above, the computing devices and systems described and/or illustrated herein broadly represent any type or form of computing device or system capable of executing computer-readable instructions, such as those contained within the code/firmware/programs described herein. In their most basic configuration, these computing device(s) each include at least one memory device and at least one physical processor.

In some examples, the term “memory device” generally refers to any type or form of volatile or non-volatile storage device or medium capable of storing data and/or computer-readable instructions. In one example, a memory device stores, loads, and/or maintains one or more of the instructions and/or circuits described herein. Examples of memory devices include, without limitation, Random Access Memory (RAM), Read Only Memory (ROM), flash memory, Hard Disk Drives (HDDs), Solid-State Drives (SSDs), optical disk drives, caches, variations, or combinations of one or more of the same, or any other suitable storage memory.

In some examples, the term “physical processor” generally refers to any type or form of hardware-implemented processing unit capable of interpreting and/or executing computer-readable instructions. In one example, a physical processor accesses and/or modifies one or more instructions stored in the above-described memory device. Examples of physical processors include, without limitation, chiplets (e.g., smaller and in some examples more specialized processing units that can coordinate as a single chip), microprocessors, microcontrollers, Central Processing Units (CPUs), Field-Programmable Gate Arrays (FPGAs) that implement softcore processors, Application-Specific Integrated Circuits (ASICs), systems on chip (SoCs), digital signal processors (DSPs), Neural Network Engines (NNEs), accelerators, accelerated processing units (APUs), portions of one or more of the same, variations or combinations of one or more of the same (e.g., a host processor and a co-processor), and/or any other suitable physical processor.

In some examples, the term “physical processor” also refers to and/or includes a co-processor that generally refers to any type or form of hardware-implemented processing unit capable of interpreting and/or executing computer-readable instructions, which in some examples works in conjunction with and/or based on instructions from a host/main processor such as a CPU, and further in some examples accesses and/or modifies one or more instructions stored in the above-described memory device. Examples of co-processors include, without limitation, chiplets, microprocessors, microcontrollers, graphics processing units (GPUs), FPGAs that implement softcore processors, ASICs, SoCs, DSPs, NNEs, accelerators, portions of one or more of the same, variations or combinations of one or more of the same, and/or any other suitable physical processor.

Although described as separate elements/steps, the instructions described and/or illustrated herein can represent portions of a single program or application, including instructions implemented in code, firmware, one or more circuits, etc. In addition, in certain implementations one or more of these instructions can represent one or more software applications or programs that, when executed by a computing device, cause the computing device to perform one or more tasks. For example, one or more of the instructions described and/or illustrated herein represent instructions stored and configured to run on one or more of the computing devices or systems described and/or illustrated herein. In some implementations, one or more instructions can be implemented as a circuit or circuitry, including as part of a firmware, a ROM, one or more logic units, etc. One or more of these instructions can also represent or otherwise be implemented with all or portions of one or more special-purpose computers configured to perform one or more tasks.

In some implementations, the term “computer-readable medium” generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

The process parameters and sequence of the steps described and/or illustrated herein are given by way of example only and can be varied as desired. For example, while the steps illustrated and/or described herein are shown or discussed in a particular order, these steps do not necessarily need to be performed in the order illustrated or discussed. The various exemplary methods described and/or illustrated herein can also omit one or more of the steps described or illustrated herein or include additional steps in addition to those disclosed.

The preceding description has been provided to enable others skilled in the art to best utilize various aspects of the exemplary implementations disclosed herein. This exemplary description is not intended to be exhaustive or to be limited to any precise form disclosed. Many modifications and variations are possible without departing from the spirit and scope of the present disclosure. The implementations disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A device comprising:
a first computing circuit configured to generate a data signal;
a link configured to send the generated data signal to a second computing circuit and receive response signals from the second computing circuit; and
a control circuit configured to simulate an active status of the link by controlling an active status visible to the first computing circuit.

2. The device of claim 1, wherein the control circuit is configured to simulate the active status by inducing and propagating the active status of the link to the first computing circuit in response to the link being inactive.

3. The device of claim 1, wherein the control circuit is configured to:
intercept an outgoing data signal for a transmit channel of the link; and
inject a mimicked response into a receive channel of the link that is paired to the transmit channel.

4. The device of claim 3, wherein the control circuit is configured to:
extract metadata from the intercepted outgoing data signal; and
apply the metadata to the mimicked response.

5. The device of claim 3, wherein the control circuit is configured to make a transmit credit available for the outgoing data signal, and wherein an availability of the transmit credit indicates the outgoing data signal is permitted to transmit.

6. The device of claim 3, wherein the control circuit is configured to decrement a transmit credit counter quota status for the outgoing data signal.

7. The device of claim 3, wherein the control circuit is configured to increment a transmit credit counter quota status by one of the mimicked responses.

8. The device of claim 3, wherein the control circuit is configured to intercept, when the link is inactive, the outgoing data signal in response to the outgoing data signal matching a packet pattern.

9. The device of claim 3, wherein the outgoing data signal corresponds to an error indication and the mimicked response corresponds to a debug command.

10. The device of claim 1, wherein the control circuit is configured to inject, in response to the link becoming inactive, a signal indicating a critical failure.

11. A system comprising:
a memory;
a first processor coupled to the memory; and
a second processor coupled to the memory;
wherein the first processor comprises:
one or more computing circuits configured to generate packets;
a link configured to send the generated packets to the second processor and receive responses from the second processor; and
a control circuit configured to simulate an active status of the link in response to an inactive status of the link by controlling the active status visible to the one or more computing circuits.

12. The system of claim 11, wherein the control circuit is further configured to simulate the active status by propagating the active status of the link to the one or more computing circuits.

13. The system of claim 11, wherein the control circuit is configured to:
intercept an outgoing data signal for a transmit channel of the link;
extract metadata from the intercepted outgoing data signal; and
inject a mimicked response based on the metadata into a response channel of the link corresponding to an initiator channel.

14. The system of claim 13, wherein the control circuit is configured to make a transmit credit available for the outgoing data signal, wherein an availability of the transmit credit indicates the outgoing data signal is permitted to transmit.

15. The system of claim 14, wherein the control circuit is configured to:
decrement a transmit credit counter quota status for the outgoing data signal; and
increment the transmit credit counter quota status for the mimicked response.

16. The system of claim 13, wherein the control circuit is configured to intercept, when the link is inactive, the outgoing data signal in response to the outgoing data signal matching a packet pattern.

17. The system of claim 13, wherein the outgoing data signal corresponds to an error indication and the mimicked response corresponds to a debug command.

18. The system of claim 11, wherein the control circuit is configured to inject, in response to the inactive status of the link, a signal that indicates a critical failure.

19. A method comprising:
intercepting, by a control circuit in response to an inactive status of a link, an outgoing data signal from one or more computing circuits;
extracting, by the control circuit, metadata from the intercepted outgoing data signal; and
propagating, by the control circuit to the one or more computing circuits, a mimicked response based on the metadata.

20. The method of claim 19, wherein at least one of the outgoing data signal or the mimicked response corresponds to an error indication.
